(19) United States
(12) Patent Application Publication
(10) Pub. No.: US 2004/0241500 A1
(43) Pub. Date: Dec. 2, 2004

(54) Magnetic recording medium, method for producing magnetic recording medium, and magnetic storage device

(76) Inventors: Akira Yano, Moriya (JP); Hideaki Yamanaka, Toride (JP); Tsuyoshi Onuma, Moriya (JP); Satoshi Matsunuma, Kamakura (JP)

Correspondence Address: BIRCH STEWART KOLASCH & BIRCH, PO BOX 747, FALLS CHURCH, VA, 22040-0747, US

(21) Appl. No.: 10/829,222

(22) Filed: Apr. 22, 2004

(30) Foreign Application Priority Data
Apr. 24, 2003 (JP) 2003-119835

(51) Int. Cl. G11B 5/17

(52) U.S. Cl. 428/694 TS; 369/13.01; 360/902

(57) ABSTRACT

The object of the present invention is to provide an artificial lattice multilayer film medium having both the excellent signal-noise ratio (S/N) and the high coercive force and demagnetization resistance by reconciling the reduction of transition noise and the high magnetic anisotropy, and a magnetic storage device having a high S/N and a high demagnetization resistance even at a high areal recording density by using the artificial lattice multilayer film medium. The magnetic recording medium of the present invention is a magnetic recording medium comprising at least a soft magnetic layer, a seed layer and a recording layer having a multilayer film structure comprising alternately laminated Co and Pd, these layers being successively laminated on a nonmagnetic substrate, where the recording layer comprises an aggregate of fcc crystal grains, the average value of (111) interplanar spacing of the fcc crystals is not more than 2.25 Å, and the recording layer additionally contains B in such an amount as satisfying 0.07 ≦concentration of B atom/(concentration of Pd atom+concentration of B atom)≦0.15.

### BACKGROUND OF THE INVENTION

The present invention relates to a magnetic recording medium, a method for producing the same, and a magnetic storage device using the same, and more particularly it relates to a magnetic recording medium for rapid and accurate storing of a large quantity of information and a method for producing the same, and a magnetic storage device using the same.

With recent development of high information-oriented societies, the need for information storage devices of large capacity and high density steadily increases. For example, magnetic storage devices used as large capacity storage devices such as large servers, parallel type computers, personal computers, network servers, movie servers, and mobile PC are composed of a magnetic head for reproduction of record and a magnetic recording medium comprising a disk-like substrate, a ferromagnetic thin film of a cobalt alloy formed on the substrate by a sputtering method, and a protective film and a lubricating film formed on the thin film for increasing sliding resistance and corrosion resistance.

With increase of capacity of magnetic storage devices, improvement of areal recording density of magnetic storage devices is being hastened. In order to record minutely the record bits, there is known so-called perpendicular magnetic recording method in which the recording magnetization direction is perpendicular to the film surface. As the material of the perpendicular magnetic recording film, a Co—Cr based polycrystal film has been used. This material compositionally separates into an area which is rich in Co and has ferromagnetism and a non-magnetic area which is rich in Cr, whereby it is realized to cut off the magnetic interaction between the ferromagnetic particles by the non-magnetic portion.

For further improvement of the areal recording density, medium noise must be reduced, and, for this purpose, it is effective to make fine the magnetization reversal unit. However, it is known that if it is too fine, the magnetization state becomes thermally unstable to cause so-called thermal demagnetization. Therefore, in order to obtain a magnetic recording medium with lower noise and capable of carrying out high density recording, thermal stability of magnetization must be further enhanced, and, for this purpose, a material having magnetic anisotropy higher than that of CoCr-based alloys must be used for a recording layer.

As the material, there is proposed, for example, a multilayer film (artificial lattice film) comprising Co and Pd or Co and Pt which are alternately laminated. However, the material suffers from the problem that since magnetic bond between crystal grains is strong, the minimum magnetic domain size is large and transition noise in the recording transition area between the adjacent record bits is great at the time of recording.

In order to solve the problem, JP-A-2002-25032 proposes a magnetic recording medium comprising a multilayer film which comprises alternately laminated Co and Pd or Co and Pt and additionally contains B and O. According to this proposal, the magnetic exchange bonding force between the ferromagnetic particles in the film plane direction is weakened by the addition of B and O to reduce the transition noise. On the other hand, the addition of B and O causes lowering of magnetic anisotropy of the recording layer, and hence the above-mentioned thermal demagnetization again becomes a problem. Furthermore, with lowering of the magnetic anisotropy, coercive force also decreases. Therefore, there also occurs a phenomenon that the reproduction output decreases in the area of high recording current at the time of recording with a magnetic head, namely, so-called recording demagnetization. A medium in which the recording demagnetization occurs cannot have stable record reproduction characteristics and hence is not suitable as a practical medium.

Because of its high magnetic anisotropy, the artificial lattice multilayer film is expected inherently to have a high resistance against thermal demagnetization. However, there is the problem that if a third element is added to reduce the transition noise, the magnetic anisotropy or the coercive force lowers to cause thermal demagnetization or recording demagnetization.

The object of the present invention is to provide a medium comprising an artificial lattice multilayer film which has both the excellent signal-noise ratio (S/N) and the high coercive force and demagnetization resistance by reconciling the reduction of transition noise and the high magnetic anisotropy, and to provide a magnetic storage device having a high S/N and a high demagnetization resistance even with a high areal recording density by using the above medium comprising the artificial lattice multilayer film.

### SUMMARY OF THE INVENTION

As a result of the intensive research conducted by the inventors for attaining the above object, it has been found that the above object can be attained by a magnetic recording medium comprising a non-magnetic substrate and at least a soft magnetic layer, a seed layer and a recording layer having a multilayer film structure comprising alternately laminated Co and Pd, these layers being successively laminated on the substrate, where the recording layer comprises an aggregate of face-centered cubic (hereinafter referred to as “fcc”) crystal grains of PdCo, the average value of (111) interplanar spacing (hereinafter referred to as “d(111)”) of the fcc crystals is not more than 2.25 Å, and the recording layer contains B in such an amount as satisfying 0.07≦CB≦0.15 in which CB means concentration of B atom/(concentration of Pd atom+concentration of B atom).

### BRIEF DESCRIPTION OF THE DRAWINGS

FIG. 1 is a schematic view showing a sectional structure of the magnetic disk of the present invention.

FIG. 2 shows relations between CB and d(111) of the magnetic disks of examples and comparative examples.

FIG. 3 shows relations between Hc and Slf/Nd of the magnetic disks of examples and comparative examples.

FIG. 4 is a diagrammatic view of the magnetic storage device of the present invention.

The reference numerals in the drawings indicate the followings.

11: Substrate

12: Adhesion layer

13: Soft magnetic layer

14: Seed layer

15: Recording layer

16: Protective layer

41: Magnetic head

42: Magnetic head driving part

43: Magnetic disk

44: Magnetic disk driving part

45: Electrical circuit system

### DETAILED DESCRIPTION OF THE INVENTION

The soft magnetic layer in the present invention is a layer for making steep the recording magnetic field at the time of recording by a magnetic head. The seed layer is a layer for controlling the crystallinity and crystal size of the recording layer.

In order to attain a recording medium high in S/N, it is effective to reduce transition noise. By the addition of B to the recording layer, B segregates at the grain boundary so that the magnetic bonding between the magnetic particles can be weakened. However, as a result of the present inventors' study, it has been found that too large amount of B has a bad influence on control of interplanar spacing of crystal grains described below. The reason for this is considered that B penetrates into PdCo crystal grains to widen the lattice spacing. Thus, the amount of B to be added is preferably 0.07≦CB≦0.15 in terms of atomic concentration ratio to Pd.

In the present invention, it is important to control interplanar spacing of crystal grains in the recording layer. The main origin of magnetic anisotropy of the Pd/Co multilayer film is interfacial anisotropy which occurs at the interface of Pd and Co, and when d(111) of PdCo-fcc crystal grains constituting the recording layer is 2.25 Å or less, a strain magnetic anisotropy induced by strain of crystal lattice is imparted and thus the recording layer develops a further higher magnetic anisotropy, resulting in a sharp increase of coercive force. As a result, a medium free from recording demagnetization or thermal demagnetization can be obtained.

If the d(111) is greater than 2.25 Å, the effect of imparting the strain magnetic anisotropy is small, and hence high magnetic anisotropy and high coercive force cannot be obtained.

In order to allow the PdCo crystal grains of the recording layer to have a d(111) of not more than 2.25 Å, it is effective to provide a seed layer as an interplanar spacing control layer just under the recording layer or to select the kind of gas or conditions at the time of sputtering formation of the seed layer and the recording layer.

As one example, a seed layer comprising at least Pd and B is formed just under the recording layer by carrying out sputtering with application of RF bias in a Kr gas atmosphere, whereby the d(111) can be 2.25 Å or less. The reason of this is considered that, due to action of Pd in the seed layer, the lattice strain introduced into the seed layer is inherited to the PdCo crystal grains in the recording layer formed on the seed layer so that growth of the PdCo crystal grains in the recording layer is controlled.

Furthermore, it is also effective to carry out the formation of the recording layer by a sputtering method using Kr gas. By the Kr gas sputtering, a lattice strain is introduced into PdCo crystal grains of the recording layer, resulting in decrease of d(111) and improvement of magnetic anisotropy.

In the magnetic recording medium of the present invention, it is preferred that the soft magnetic backing layer is formed of an alloy mainly composed of at least one of Co and Fe and containing additionally at least one element of B and C. Furthermore, the soft magnetic backing layer may be formed of an amorphous alloy mainly composed of CoZr and further containing at least one element selected from the group consisting of Ta, Nb and Ti. Moreover, the soft magnetic backing layer may be formed of an alloy having a structure comprising Fe in which is dispersed a nitride or a carbide of at least one element selected from the group consisting of Ta, Nb and Zr.

As the substrate of the magnetic recording medium of the present invention, there may be used a non-magnetic substrate such as an aluminum-magnesium alloy substrate, a glass substrate, a graphite substrate, or the like.

An adhesion layer such as of Ti may be formed on the substrate of the magnetic recording medium before formation of the soft magnetic layer in order to improve adhesion to the substrate.

According to the present invention, there may be provided a magnetic storage device which contains the magnetic recording medium of the present invention and which is high in S/N and excellent in demagnetization resistance and capable of performing high density recording.

### DESCRIPTION OF PREFERRED EMBODIMENT

The magnetic recording medium, the method for producing the magnetic recording medium, and the magnetic storage device of the present invention will be specifically explained below using examples. A magnetic disk (a hard disk) was used as the magnetic recording medium, but the present invention is also applicable to recording media such as flexible disks, magnetic tapes and magnetic cards, in which the recording head contacts with the magnetic recording medium.

### EXAMPLE 1

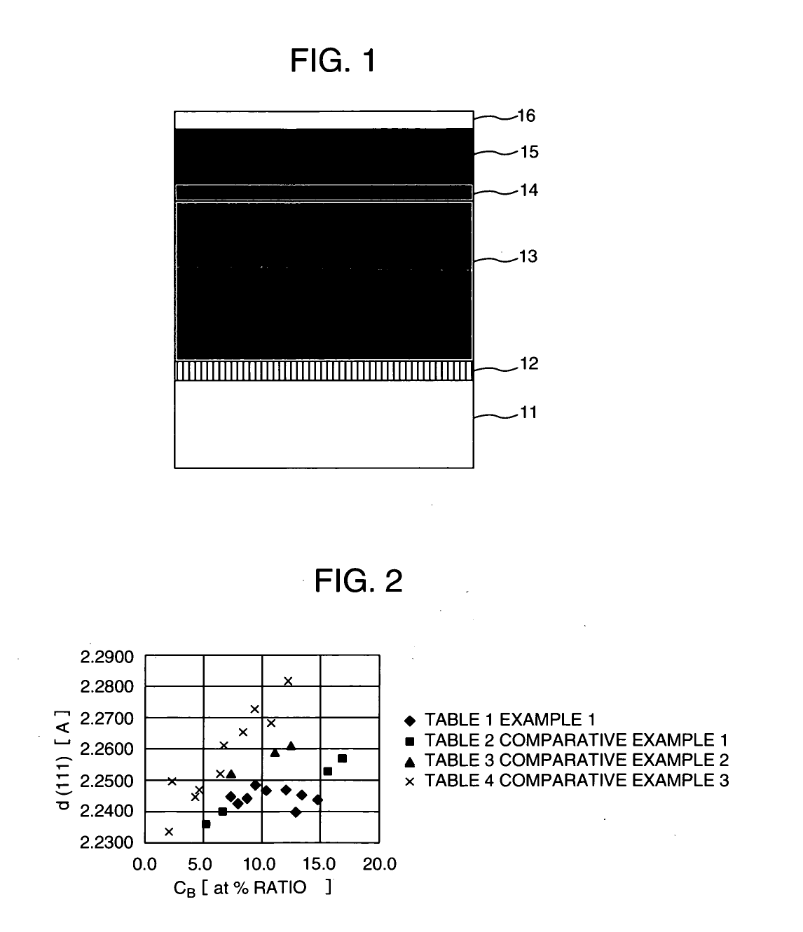

FIG. 1 shows a schematic sectional view of a magnetic disk made in Example 1. As shown in FIG. 1, the magnetic disk was made by successively laminating on a substrate 11 an adhesion layer 12, a soft magnetic layer 13, a seed layer 14, a recording layer 15 and a protective layer 16. The adhesion layer 12 is a layer for inhibiting separation of the substrate 11 and the laminate film, and the soft magnetic layer 13 is a layer for providing a steep recording magnetic field at the time of recording with a magnetic head. The seed layer 14 is a layer for controlling the crystallinity or crystal size of the recording layer 15, and the recording layer 15 is a layer in which information is recorded as a magnetized information, and the magnetization direction in the recording layer 15 is perpendicular to the film surface. The protective layer 16 is a layer for protecting the laminate films 12-15 which are successively laminated on the substrate 11.

The magnetic recording medium in the magnetic storage device in this Example was produced using a continuous sputtering apparatus comprising a plurality of linked sputter chambers.

First, a Ti film of 5 nm thick was formed as the adhesion layer 12 on a glass substrate of 2.5 inches in diameter in an Ar gas atmosphere by DC magnetron sputtering method.

Then, on the adhesion layer 12 was formed a CoB film as the soft magnetic layer 13 by DC magnetron sputtering method using a Co80B20 alloy target in an Ar gas atmosphere. The thickness of the soft magnetic layer 13 was 200 nm.

Furthermore, on the soft magnetic layer 13 was formed a PdB film as the seed layer 14. The film was formed by DC magnetron sputtering method using a Pd50B50 alloy target in a Kr gas atmosphere. In this case, an RF bias was applied to the surface of the substrate by applying an RF electric power of 150 W onto the substrate side. The thickness of the seed layer 14 was 3 nm.

A CoB/PdB alternate multilayer film showing perpendicular magnetization was formed as the recording layer 15 on the above-formed seed layer 14. The formation of the CoB/PdB alternate multilayer film was carried out by a target rotating type sputter chamber capable of performing ternary simultaneous sputtering. While the ternary targets were revolutionarily rotated, Co target and B target were subjected to simultaneous discharging at the time of the formation of the CoB layer, and Pd target and B target were subjected to simultaneous discharging at the time of the formation of the PdB layer. Co and Pd were sputtered by DC magnetron method and B was sputtered by RF magnetron method. Kr gas was used as the sputtering gas, and the number of rotation was 100 rpm.

Magnetic disks differing in thickness of PdB layer and CoB layer and in CB were produced by adjusting the discharging power of Co, that of Pd and that of B within the ranges of 40-50 W, 40-50 W and 0-300 W, respectively. In a part of disks, a Co/PdB multilayer film which did not contain B in the Co layer was prepared. Moreover, magnetic disks were produced with changing the Kr gas flow rate within a range of 140-200 sccm.

Finally, a C film was formed as the protective layer 16 on the recording layer 15 by DC magnetron sputtering method in an Ar gas atmosphere. The thickness of the protective layer 16 was 3 nm.

Crystal structure of the resulting magnetic disks was analyzed by an X-ray diffraction apparatus. Cu-kα ray was used as the X-ray source, and θ-2θ curve was measured by a wide angle X-ray diffraction method. Here, θ is an angle of incidence of X-ray to the film surface of the disk, and 20 is an angle of diffraction of X-ray. The (111) interplanar spacing of PdCo crystal grains was obtained from the position of the diffraction peak from the (111) plane of fcc-PdCo crystal grains.

Furthermore, the composition of the recording layer of the resulting magnetic disk was analyzed in the depth direction using X-ray photo-electron spectroscopy (XPS). B atom concentration/(Pd atom concentration+B atom concentration)=CB was calculated from the atom concentrations of Pd and B of the recording layer.

The magnetic characteristics of the resulting magnetic disk were measured by Kerr rotation angle measuring apparatus. The coercive force (Hc) in perpendicular direction was obtained from the hysteresis curve in perpendicular direction of the recording layer.

Then, a lubricant (not shown) was coated on the protective layer 16 of the magnetic disk, and thereafter the recording and reproducing characteristics of the magnetic disks were evaluated. For the evaluation, a spin stand type recording and reproducing device was used. For recording, a single magnetic pole head suitable for perpendicular magnetic recording was used, and a spin valve type GMR magnetic head was used for reproduction. The distance between the face of the magnetic head and that of the magnetic disk was kept at 10 nm. The reproduction output Slf when a signal of 20 kFCI in linear recording density was recorded and the noise Nd when a signal of 450 kFCI in linear recording density was recorded were measured, and Slf/Nd was calculated. The Slf/Nd was an indication of S/N of the medium.

Furthermore, recording and reproduction were carried out with changing the head current at the time of recording within the range of 10-50 mA, and evaluation was carried out on whether reduction of the reproduction output in the area of high recording current (high recording magnetic field) occurred or not, namely, whether recording demagnetization occurred or not. Stable recording and reproduction cannot be obtained in the magnetic disk in which recording demagnetization occurs, and hence this magnetic disk is not suitable as a practical recording medium.

Table 1 shows Kr flow rate, thickness of PdB and CoB of the recording layer, CB, d(111), Hc, Slf/Nd, and occurrence of recording demagnetization of the magnetic disks produced in Example 1. The magnetic disks of Example 1 had a d(111) of not more than 2.25 Å and a CB of 0.07≦CB≦0.15. All of the disks had a high Hc of not lower than 4 kOe and did not show the recording demagnetization. Furthermore, all of the disks had an excellent Slf/Nd of not lower than 25 dB.

TABLE 1

| | Kr | | | | | | | |
|---|---|---|---|---|---|---|---|---|
| | flow | PdB | CoB | | | | | |
| Disk | rate | thickness | thickness | C_{B} | d(111) | Hc | Slf/Nd | Recording |
| No. | [sccm] | [nm] | [nm] | [at % ratio] | [Å] | [kOe] | [dB] | demagnetization |
| 1-1 | 140 | 0.82 | 0.16 | 7.8 | 2.2430 | 6.1 | 25.4 | No |
| 1-2 | 140 | 1.00 | 0.17 | 8.6 | 2.2452 | 5.1 | 25.8 | No |
| 1-3 | 140 | 1.23 | 0.19 | 9.4 | 2.2489 | 4.7 | 25.6 | No |
| 1-4 | 170 | 1.02 | 0.17 | 10.2 | 2.2473 | 4.1 | 26.8 | No |
| 1-5 | 170 | 1.21 | 0.18 | 7.3 | 2.2452 | 4.4 | 25.8 | No |
| 1-6 | 170 | 0.88 | 0.19 | 14.6 | 2.2441 | 4.2 | 25.7 | No |
| 1-7 | 200 | 1.22 | 0.16 | 13.3 | 2.2457 | 4.2 | 26.3 | No |
| 1-8 | 200 | 0.82 | 0.18 | 11.9 | 2.2473 | 5.0 | 27.0 | No |
| 1-9 | 200 | 0.99 | 0.18 | 12.8 | 2.2403 | 5.6 | 25.6 | No |

### COMPARATIVE EXAMPLE 1

Magnetic disks were produced in the same manner as in Example 1, except that the discharging power of each target at the time of the formation of the recording layer was adjusted so as to give CB<0.07 or CB>0.15. Table 2 shows the Kr flow rate, thickness of PdB and CoB of the recording layer, CB, d(111), Hc, Slf/Nd, and occurrence of recording demagnetization of the magnetic disks obtained in Comparative Example 1. The disk of CB<0.07 was high in Hc, but low in S/N, and the disk of CB>0.15 was low in Hc and hence caused recording demagnetization.

TABLE 2

| | Kr | | | | | | | |
|---|---|---|---|---|---|---|---|---|
| | flow | PdB | CoB | | | | | |
| Disk | rate | thickness | thickness | C_{B} | d(111) | Hc | Slf/Nd | Recording |
| No. | [sccm] | [nm] | [nm] | [at % ratio] | [Å] | [kOe] | [dB] | demagnetization |
| 2-1 | 140 | 0.82 | 0.16 | 5.2 | 2.2361 | 7.0 | 22.5 | No |
| 2-2 | 140 | 0.82 | 0.18 | 6.6 | 2.2403 | 6.9 | 23.1 | No |
| 2-3 | 140 | 0.82 | 0.16 | 15.5 | 2.2532 | 3.2 | 24.0 | Occurred |
| 2-4 | 140 | 0.82 | 0.18 | 16.7 | 2.2576 | 2.6 | 20.6 | Occurred |

### COMPARATIVE EXAMPLE 2

Magnetic disks were produced in the same manner as in Example 1, except that the RF bias was not applied at the time of the formation of the PdB seed layer. Table 3 shows the Kr flow rate, thickness of PdB and CoB of the recording layer, CB, d(111), Hc, Slf/Nd, and occurrence of recording demagnetization of the magnetic disks obtained in Comparative Example 2. In Comparative Example 2, the lattice strain was imparted insufficiently, resulting in d(111)>2.25 Å in the case of 0.07≦CB. Therefore, the magnetic anisotropy and Hc lowered to cause recording demagnetization.

TABLE 3

| | Kr | | | | | | | |
|---|---|---|---|---|---|---|---|---|
| | flow | PdB | CoB | | | | | |
| Disk | rate | thickness | thickness | C_{B} | d(111) | Hc | Slf/Nd | Recording |
| No. | [sccm] | [nm] | [nm] | [at % ratio] | [Å] | [kOe] | [dB] | demagnetization |
| 3-1 | 140 | 0.82 | 0.16 | 7.3 | 2.2527 | 3.7 | 23.8 | Occurred |
| 3-2 | 140 | 0.82 | 0.16 | 11 | 2.2597 | 2.8 | 20.9 | Occurred |
| 3-3 | 140 | 0.82 | 0.16 | 12.4 | 2.2614 | 1.8 | 20.6 | Occurred |

### COMPARATIVE EXAMPLE 3

Magnetic disks were produced in the same manner as in Example 1, except that the recording layer and the seed layer were formed by sputtering with Ar gas and the Ar gas flow rate was changed within the range of 80-200 sccm. Table 4 shows the Ar flow rate, thickness of PdB and CoB of the recording layer, CB, d(111), Hc, Slf/Nd, and occurrence of recording demagnetization of the magnetic disks obtained in Comparative Example 3. With increase of CB, d(111) conspicuously increased and Hc abruptly decreased. The disk of CB=0.02 (Disk No.4-5) had an Hc of 4.1 kOe, but was low in Slf/Nd, namely, 19.4 dB. In all of other disks, recording demagnetization occurred because of low Hc.

TABLE 4

| | Ar | | | | | | | |
|---|---|---|---|---|---|---|---|---|
| | flow | PdB | CoB | C_{B} | | | | |
| Disk | rate | thickness | thickness | [at % | d(111) | Hc | Slf/Nd | Recording |
| No. | [sccm] | [nm] | [nm] | ratio] | [Å] | [KOe] | [dB] | demagnetization |
| 4-1 | 80 | 0.90 | 0.14 | 2.3 | 2.2500 | 2.9 | 20.1 | Occurred |
| 4-2 | 80 | 0.90 | 0.18 | 6.3 | 2.2527 | 2.8 | 23.2 | Occurred |
| 4-3 | 140 | 0.90 | 0.18 | 4.2 | 2.2452 | 3.9 | 22.1 | Occurred |
| 4-4 | 140 | 0.90 | 0.14 | 6.6 | 2.2614 | 1.8 | 22.9 | Occurred |
| 4-5 | 200 | 0.90 | 0.18 | 2 | 2.2339 | 4.1 | 19.4 | No |
| 4-6 | 200 | 0.90 | 0.14 | 4.5 | 2.2473 | 2.8 | 20.2 | Occurred |
| 4-7 | 80 | 0.80 | 0.17 | 10.7 | 2.2690 | 1.6 | 19.9 | Occurred |
| 4-8 | 80 | 1.00 | 0.20 | 8.3 | 2.2657 | 1.8 | 23.7 | Occurred |
| 4-9 | 140 | 0.80 | 0.14 | 9.3 | 2.2734 | 0.8 | Unmeasurable | Unmeasurable |
| 4-10 | 140 | 1.00 | 0.17 | 12.2 | 2.2823 | 0.5 | Unmeasurable | Unmeasurable |

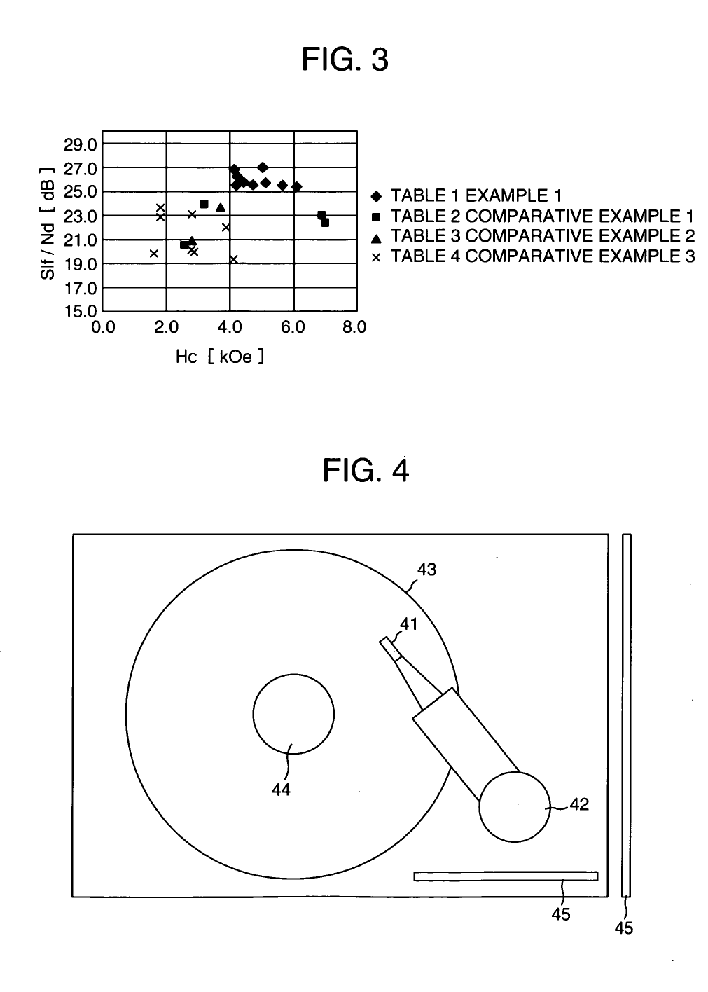

The relation between CB and d(111) of the magnetic disks of Example 1 and Comparative Examples 1-3 is shown in FIG. 2, and the relation between Hc and Slf/Nd of the magnetic disks of Example 1 and Comparative Examples 1-3 is shown in FIG. 3. All of the magnetic disks of Example 1 had a d(111) of not more than 2.25 Å, a CB of 0.07≦CB≦0.15, a high Hc of not lower than 4 kOe, and an excellent Slf/Nd of not less than 25 dB.

The magnetic disk No.1-8 produced in Example 1 was mounted in a magnetic storage device as shown in FIG. 4, and a recording and reproducing test of the magnetic disk was conducted. This magnetic storage device comprised mainly a magnetic head 41, a magnetic head driving part 42 which controls the magnetic head, a driving part 44 for rotating a magnetic disk 43, and an electrical circuit system 45 for signal processing. A magnetic head for recording and a magnetic head for reproduction were integrated in the magnetic head 41. A dual spin valve type magnetic head having a high saturation magnetic flux density of 2.1 T was used as the magnetic head for recording.

Here, a signal corresponding to 80 Gbits/in² was recorded in the magnetic disk 43. The distance between the face of the magnetic head and the surface of the magnetic disk in the magnetic storage device was kept at 10 nm. As a result of the reproduction test, a reproduction signal of signal-noise ratio S/N=29 dB was obtained, and error rate was less than 1×10⁻⁵ in case the signal processing was not carried out.

According to the present invention, there are obtained magnetic recording media having a high Hc, showing no recording demagnetization, and having a low medium noise and a high S/N. Furthermore, there can be provided magnetic storage devices provided with the magnetic recording media of the present invention which are capable of performing high density recording of 80 Gbits/in² or higher.

What is claimed is:

1. A magnetic recording medium comprising a non-magnetic substrate and at least a soft magnetic layer, a seed layer and a recording layer having a multilayer film structure comprising alternately laminated Co and Pd which are successively laminated on the substrate, where the recording layer contains B in an amount satisfying 0.07≦concentration of B atom/(concentration of Pd atom+concentration of B atom)≦0.15, the recording layer comprises an aggregate of fcc crystal grains, and the average value of (111) interplanar spacing of the fcc crystals is not more than 2.25 Å.

2. A magnetic recording medium according to claim 1, wherein the seed layer comprises Pd and B.

3. A method for producing the magnetic recording medium of claim 1, wherein the seed layer is formed by sputtering under application of RF bias.

4. A method for producing the magnetic recording medium of claim 2, wherein the seed layer is formed by sputtering under application of RF bias.

5. A method for producing the magnetic recording medium of claim 1, wherein Kr gas is used for the formation of the seed layer and the recording layer by sputtering.

6. A method for producing the magnetic recording medium of claim 2, wherein Kr gas is used for the formation of the seed layer and the recording layer by sputtering.

7. A magnetic storage device having the magnetic recording medium of claim 1, a magnetic head for recording information in the magnetic recording medium or reproducing the recorded information, a driving means for driving the magnetic recording medium in respect to the magnetic head, and a recording and reproducing signal processing means for signal inputting with the magnetic head and reproduction of the output signal from the magnetic head.

8. A magnetic storage device having the magnetic recording medium of claim 2, a magnetic head for recording information in the magnetic recording medium or reproducing the recorded information, a driving means for driving the magnetic recording medium in respect to the magnetic head, and a recording and reproducing signal processing means for signal inputting with the magnetic head and reproduction of the output signal from the magnetic head.
